(19) United States
(12) Patent Application Publication
(10) Pub. No.: US 2009/0201817 A1
(43) Pub. Date: Aug. 13, 2009

(54) METHOD OF OPTIMIZING A FLOW OF VALUE IN A NETWORK

(75) Inventors: Rama K. Akkiraju, San Jose, CA (US); Alain E. Biem, Mount Kisco, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/028,408

(22) Filed: Feb. 8, 2008

(51) Int. Cl. G08C 15/00

(52) U.S. Cl. 370/238

(57) ABSTRACT

A method of modeling flow between first and second economic entities (EEs), where the first and second EEs interact either directly or indirectly with other, including defining a network to which the first and second EEs belong, expressing economic interactions of each of the EEs in the network and for each economic interaction, determining first and second value transfers, which are respectively defined as a total of a set of transfers of value from one EE to another, and vice versa, and expressing a flow based on an absolute value of a difference between the first and the second value transfers, determining a value of a wallet of each of the EEs in the network based on external information, and calculating a maximum flow from the first EE to the second EE.

### BACKGROUND OF THE INVENTION

1. Field of the Invention

Aspects of the present invention relate to a method of optimizing a flow of value and, more particularly, to a method of optimizing a flow of value in a network of businesses.

2. Description of the Background

A value network refers to a network of economic entities (EEs), such as enterprises, organizations, or people, which are related to each other through economic interactions, such as coordinated partnerships with one another to achieve a common goal or market interactions. That is, the EEs may interact with one another through buyer-and-seller relationships, strategic alliances, or out-sourcing deals. These and other interactions are manifested by value being exchanged between the two interacting entities. This value may be characterized by monetary exchanges or by a monetary payment in return for services rendered or by intangible benefits such as access to a partner's expertise.

When viewed through the prism of a graph of the network, these interactions are substantially equivalent to value being passed from a node of the network to another node in the network. In a particular form of such a graph, referred to as a flow network, each edge of the graph has a capacity and receives a flow. The amount of flow on an edge may not exceed the capacity of the edge and must satisfy the restriction that the amount of flow into a node equals the amount of flow out of it, except where the node is a source, which has more outgoing flow, or where the node is a sink, which has more incoming flow.

### SUMMARY OF THE INVENTION

In accordance with an embodiment of the invention, a method of modeling flow between first and second economic entities (EEs), where the first and second EEs interact either directly or indirectly with other entities, is provided and includes defining a network to which the first and second EEs belong, expressing economic interactions of each of the EEs in the network and for each economic interaction, determining first and second value transfers, which are respectively defined as a total of a set of transfers of value from one EE to another, and vice versa, and expressing a flow based on an absolute value of a difference between the first and the second value transfers, determining a value of a wallet of each of the EEs in the network based on external information, and calculating a maximum flow from the first EE to the second EE by modeling each possible path through the network from the first EE to the second EE based on the expressed flows for each economic interaction, filtering undesirable paths until a single path remains unfiltered, and assigning the value of the least valuable wallet of each of the EEs along the single path as the maximum flow.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a diagram of a transformation of network of economic entities into a network flow in accordance with an exemplary embodiment of the present invention; and

FIG. 2 is a flow diagram that illustrates a method of finding an optimal flow of value in a network of economic entities in accordance with an exemplary embodiment of the invention.

### DETAILED DESCRIPTION OF THE INVENTION

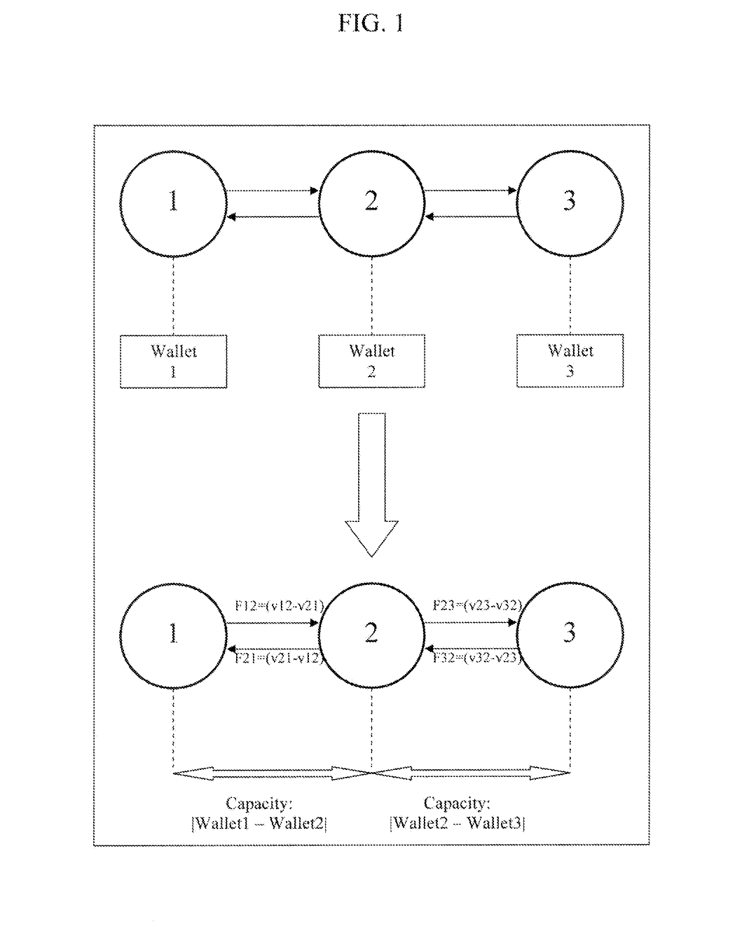

With reference to FIG. 1, it is noted that nodes 1, 2 and 3 are economic entities (EEs) and that arrows V12, V21, V23 and V32 represent their common interactions. The flows F12 and F21 respectively represent differences between the value transferred from node 1 to node 2 and the value transferred from node 2 to node 1. Similarly, flows F23 and F32 respectively represent differences between the value transferred from node 2 to node 3 and the value transferred from node 3 to node 2. Each node has a wallet, which is defined as the largest amount of value that can be transferred from one node to another. Therefore, it may be seen that flow F12, for example, cannot exceed the wallet of node 2. Similarly, flows F21 and F23 as well as flow F32 cannot exceed the wallets of nodes 2 and 3, respectively.

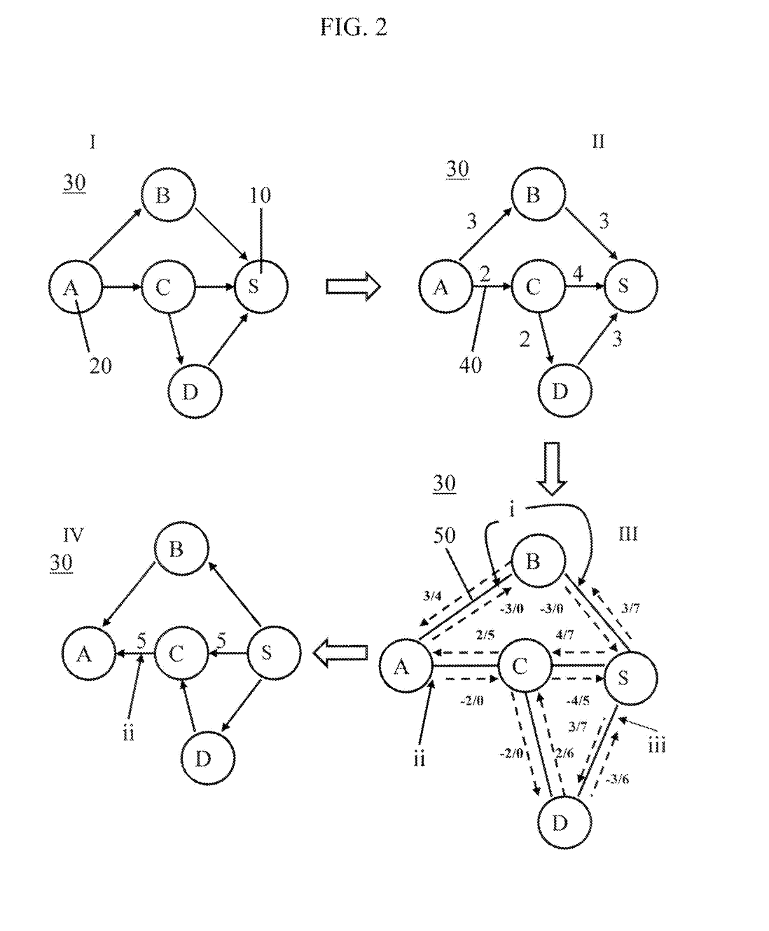

With the above discussion set forth and with reference to FIG. 2, a method of modeling a flow between first and second economic entities (EEs) 10 and 20 will now be described. The method initially comprises defining a network 30 to which the first and second EEs 10 and 20 belong. This necessary first operation allows the network 30 to be seen from among the countless EEs in existence, most of which either have immeasurable or otherwise trivial interactions with the first and second EEs 10 and 20.

In FIG. 2, the initial operation of defining the network 30 may be seen in graph I of FIG. 2. Here, the network 30 is defined as including nodes A, B, C, D and S, each of which represents an EE. It follows then, as shown in graph I, that node A represents an EE that interacts with the EEs represented by nodes B and C, node B represents an EE that interacts with the EE of node S, and so on.

In setting up the definition of the network 30, it is understood that a level of detail of the network 30 must be predetermined. That is, it must be decided whether to limit the network 30 to those EEs that directly interact with the first and second EEs 10 and 20 or to open the network 30 up to EEs that directly and indirectly interact with the first and second EEs. If the network is to be opened up to indirectly acting EEs, it must then be determined how many orders of separation the network 30 is to include. For example, while nodes S and A, respectively representing the first and second EEs 10 and 20 do not directly interact with each other, the EEs represented by nodes B, C and D interact with both on either first or second order levels. Thus, it can be seen that the graph I of the network 30 is, at least, first or second ordered.

Once the network 30 is set up, each economic interaction 40 of each of the EEs in the network 30 is expressed, including those of the first and second EEs 10 and 20, as an economic interaction between first and second actors. The expression of these economic interactions is shown, in graph II of FIG. 2, as arrows between nodes having values attached to them. That is, values of quantities 3 and 2 are sent from the EE represented by node A to the EEs represented by nodes B and C, respectively.

Referring now to graph III of FIG. 2, it is noted that for each economic interaction a flow 50 between nodes is expressed and may be seen as the set of lines between the nodes in graph III. Each of the flows 50 is actually representative of the absolute value of a difference between the value sent from a node and the value received by the node in “payment” for the value sent. That is, where graph II shows the EE represented by node A sending a value of quantity 3 to node B, graph III shows that the EE of node B returns a payment of value to the EE of node A. The absolute value of the difference between the values sent from node A to node B and vice versa is the flow 50 from B to A. In this case, the value of the flow 50 has a quantity of 3.

This quantity of the flow 50 from node B to node A is illustrated by the presence of the number “3” in the fraction associated with the flow 50 (the denominator in this fraction is a representation of the wallet of node B, which will be discussed below). Of course, it is understood that the value being transferred from node A to node B may also be a payment, while the value being sent from node B to A may be something other than a payment. It is further understood that the flow 50 could point in either direction.

Still referring to graph III, it is noted that a value of a wallet of each of the EEs represented by the nodes is determined from external information and, as described above, the wallet of each of the represented EEs is the maximum value that could be transferred to another node. That is, as shown in graph III, the EE represented by node C has a quantity of 5 and, as such, a maximum value of only quantity 5 can be sent from node C to node A, node S or node B.

The external information by which the wallet sizes of the EEs are determined may be, e.g., financial records of the corresponding EEs where such records are available or, alternately, estimates of financial positions of the corresponding EEs.

Once the wallets of the represented EEs are determined, it may be seen from graph III that a maximum flow from the first EE 10, represented by node S, to the second EE 20, represented by node A, can be calculated. The calculation of the maximum flow is accomplished by first modeling each possible path from the first EE 10 to the second EE 20 based on the expressed flows for each economic interaction. That is, as shown in graph III, the paths proceeding toward node A from node S are path i (node S to node B to node A), path ii (node S to node C to node A) and path iii (node S to node D to node C to node A).

The next operation involves filtering undesirable paths until a single path remains unfiltered. This may be accomplished by analyzing the flows that proceeds toward node A along the paths i, ii and iii and determining which paths involve the largest set of wallets. That is, as shown in graph III, since path ii involves the wallet of the EE represented by node S, which has a value of quantity 7, and the wallet of the EE represented by node C, which has a value of quantity 5, path ii is the most direct route involving nodes representing EEs having the largest wallets.

Once the path is determined, the value of the least valuable wallet of each of the EEs represented by the nodes along the path is assigned as the maximum flow for the path. In the case of graph III, the assigned value for path ii is, therefore, a quantity of 5. The limitation of this assignment of value is due to the recognition that while the EE represented by node C can receive value of quantity 7 from the EE represented by node S, the largest quantity of value node C can send to node A is 5 regardless.

Graph IV of FIG. 2 illustrates the fact that a flow of quantity 5 is the maximum flow that can be transferred to node A along path ii in accordance with the discussion provided above.

In accordance with an embodiment of the invention, the method may further comprise operating the first and/or the second EEs 10 and/or 20 based on the calculated maximum flow. That is, if a decision is to be made in the EE represented by node A as to which EEs to partner with, such as decision could be influenced by the information to be derived from graph IV. That is, that the EE represented by node could receive the largest maximum flow from the EEs represented by the nodes of path ii. Therefore, a decision could be made in the EE represented by node A to partner with the EEs represented by nodes C and S. in order to maximize flow.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

We claim:

1. A method of modeling flow between first and second economic entities (EEs), where the first and second EEs interact either directly or indirectly with other, the method comprising:
defining a network to which the first and second EEs belong;
expressing economic interactions of each of the EEs in the network and for each economic interaction:
determining first and second value transfers, which are respectively defined as a total of a set of transfers of value from one EE to another, and vice versa, and
expressing a flow based on an absolute value of a difference between the first and the second value transfers;
determining a value of a wallet of each of the EEs in the network based on external information; and
calculating a maximum flow from the first EE to the second EE by:
modeling each possible path through the network from the first EE to the second EE based on the expressed flows for each economic interaction,
filtering undesirable paths until a single path remains unfiltered, and
assigning the value of the least valuable wallet of each of the EEs along the single path as the maximum flow for the corresponding path.

2. The method according to claim 1, wherein the network may include EEs of varying orders.

3. The method according to claim 1, wherein the wallet of each of the EEs is a maximum amount of money that can be transferred from the EE to another EE.

4. The method according to claim 3, wherein the expressed flow is a percentage of the wallet of the EE from which the flow originates.

5. The method according to claim 1, further comprising operating the first and/or the second EE based on the calculated maximum flow.
